(19) United States
(12) Patent Application Publication
(10) Pub. No.: US 2023/0385616 A1
(43) Pub. Date: Nov. 30, 2023

(54) SPIKE NEURAL NETWORK CIRCUIT AND METHOD OF OPERATION THEREOF

(71) Applicant: Electronics and Telecommunications Research Institute, Daejeon (KR)

(72) Inventors: Kwang IL OH, Daejeon (KR); Byung-Do YANG, Daejeon (KR); Dongwon LEE, Daejeon (KR); Jae-Jin LEE, Daejeon (KR)

(73) Assignee: Electronics and Telecommunications Research Institute, Daejeon (KR)

(21) Appl. No.: 18/125,552

(22) Filed: Mar. 23, 2023

(30) Foreign Application Priority Data
May 27, 2022 (KR) 10-2022-0065566

(51) Int. Cl. G06N 3/049; G06N 3/063

(52) U.S. Cl. CPC G06N 3/049; G06N 3/063

(57) ABSTRACT

Disclosed is a spike neural network circuit including a weight storage that receives an input spike signal and outputs data based on a weight, a charge sharing synaptic circuit that generates a synaptic voltage based on the output data, a switched capacitor circuit that naturally discharges the generated synaptic voltage, a voltage-to-current conversion circuit that receives the synaptic voltage and generates a membrane voltage, and a neuron circuit that receives the membrane voltage and a threshold voltage and generates an output spike signal based on the received membrane voltage and the received threshold voltage.

### CROSS-REFERENCE TO RELATED APPLICATIONS

This application claims priority under 35 U.S.C. § 119 to Korean Patent Application No. 10-2022-0065566 filed on May 27, 2022, in the Korean Intellectual Property Office, the disclosures of which are incorporated by reference herein in their entireties.

### BACKGROUND

Embodiments of the present disclosure described herein relate to a spike neural network circuit and an operating method thereof, and more particularly, relate to a spike neural network circuit imitating a biological action and an operating method thereof.

A spike neural network refers to one of methods of implementing an artificial intelligence network, and outputs an output by performing a network operation on an applied spike input. The spike neural network performs an operation in a form of a pulse or spike having a short time width. In particular, when a pulse having a specific period is applied to an input of a network, a network operation is performed at a specific node, and a spike is delivered to the next node along a spike delivery path.

Elements, each of which performs the network operation, include a synapse and a neuron. The synapse applies a synaptic weight to an input spike, and then delivers the result to an input of a neuron connected to the synapse. In this case, a plurality of synapses may be connected to the input of one neuron. A membrane potential is formed by accumulating the calculation result received from the synapse in a membrane. When the membrane potential exceeds a reference potential (threshold) for the firing of the corresponding neuron, a neuron outputs a pulse having a short time width.

The above mechanism may be implemented with a semiconductor circuit composed of MOSFETs. That is, a synapse operation is expressed in a computational form of charge. The amount of current flowing may be adjusted by using the MOSFETs. The current or charge amount accumulated in a membrane capacitor connected to an input of a neuron circuit forms a membrane potential, which is delivered to the neuron circuit.

### SUMMARY

Embodiments of the present disclosure provide a spike neural network circuit that mimics a biological action, and an operating method thereof.

According to an embodiment, a spike neural network circuit includes a weight storage that receives an input spike signal and outputs data based on a weight, a charge sharing synaptic circuit that generates a synaptic voltage based on the output data, a switched capacitor circuit that naturally discharges the generated synaptic voltage, a voltage-to-current conversion circuit that receives the synaptic voltage and generates a membrane voltage, and a neuron circuit that receives the membrane voltage and a threshold voltage and generates an output spike signal based on the received membrane voltage and the received threshold voltage.

According to an embodiment, an operating method of a spike neural network circuit includes receiving an input spike signal and outputting data based on a weight, generating a synaptic voltage based on the output data, naturally discharging the generated synaptic voltage, receiving the synaptic voltage and generating a membrane voltage, comparing the membrane voltage with a threshold voltage, and generating an output spike signal in response to an event that the comparison result indicates that the membrane voltage exceeds the threshold voltage.

### BRIEF DESCRIPTION OF THE FIGURES

The above and other objects and features of the present disclosure will become apparent by describing in detail embodiments thereof with reference to the accompanying drawings.

FIG. 1 is a block diagram showing a spike neural network circuit.

FIG. 2 is a timing diagram illustrating an operation of the spike neural network circuit of FIG. 1.

FIG. 3 is a block diagram illustrating a spike neural network circuit, according to an embodiment of the present disclosure.

FIG. 4 shows a charge sharing synaptic circuit, according to an embodiment of the present disclosure.

FIG. 5 is a timing diagram illustrating an operation of the charge sharing synaptic circuit of FIG. 4.

FIG. 6 shows a switched capacitor circuit, according to an embodiment of the present disclosure.

FIG. 7 is a timing diagram showing an operation of the switched capacitor circuit of FIG. 6.

FIG. 8 shows a voltage-to-current conversion circuit, according to an embodiment of the present disclosure.

FIG. 9 shows an equivalent circuit of the voltage-to-current conversion circuit of FIG. 8.

FIG. 10 shows a neuron circuit, according to an embodiment of the present disclosure.

FIG. 11 is a timing diagram illustrating an operation of a spike neural network circuit, according to an embodiment of the present disclosure.

FIG. 12 is a flowchart illustrating an operation of a spike neural network circuit, according to an embodiment of the present disclosure.

### DETAILED DESCRIPTION

Below, embodiments of the present disclosure will be described in detail and clearly to such an extent that an ordinary one in the art easily implements the present disclosure.

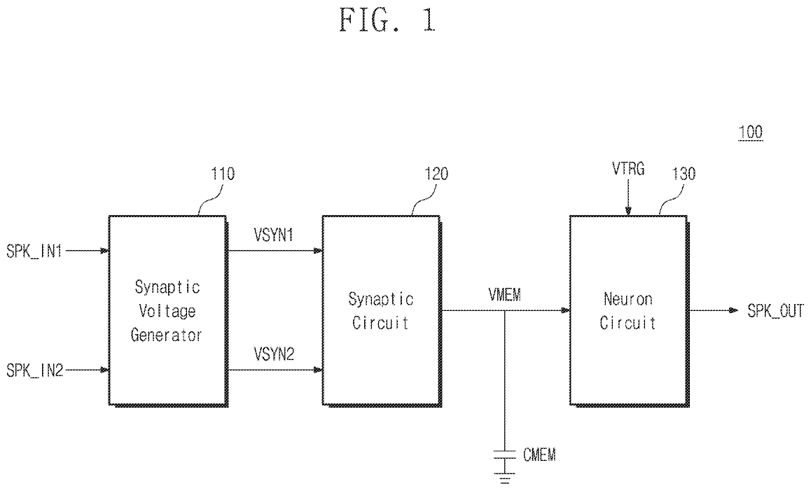

FIG. 1 is a block diagram showing a spike neural network circuit 100. Referring to FIG. 1, the spike neural network circuit 100 may include a synaptic voltage generator 110, a synaptic circuit 120, and a neuron circuit 130.

The synaptic voltage generator 110 may receive at least one input spike signal from the outside. For example, the synaptic voltage generator 110 may receive first and second input spike signals SPK_IN1 and SPK_IN2 from the outside.

The synaptic voltage generator 110 may generate at least one synaptic voltage based on the received input spike signal. For example, the synaptic voltage generator 110 may generate first and second synaptic voltages VSYN1 and VSYN2 based on the first and second input spike signals SPK_IN1 and SPK_IN2. In this case, the generated first and second synaptic voltages VSYN1 and VSYN2 may decrease in units of a time constant of several milliseconds (ms) depending on natural decay. That is, the first and second synaptic voltages VSYN1 and VSYN2 may have synapse short-term plasticity characteristics.

The synaptic circuit 120 may receive a synaptic voltage from the synaptic voltage generator 110. For example, the synaptic circuit 120 may receive the first and second synaptic voltages VSYN1 and VSYN2 from the synaptic voltage generator 110.

The synaptic circuit 120 may generate a membrane voltage VMEM based on the received synaptic voltage. For example, the synaptic circuit 120 may generate the membrane voltage VMEM based on the first and second synaptic voltages VSYN1 and VSYN2.

Although not shown in drawings, the synaptic circuit 120 may include a current-mode digital-to-analog converter (C-DAC) and a weight memory.

The weight memory may store a predefined weight value and may provide the stored weight value to the C-DAC. The weight memory may be implemented with a binary memory.

The C-DAC may supply a current or charge to the neuron circuit 130 based on the weight provided from the weight memory. Alternatively, the C-DAC may supply charges to a membrane capacitor CMEM based on the weight provided from the weight memory.

The spike neural network circuit 100 may further include the membrane capacitor CMEM connected in parallel between the synaptic circuit 120 and the neuron circuit 130. The membrane capacitor CMEM may receive charges from the synaptic circuit 120. The membrane capacitor CMEM may form the membrane voltage VMEM by accumulating the received charges.

The neuron circuit 130 may receive the membrane voltage VMEM from the synaptic circuit 120. The neuron circuit 130 may receive a threshold voltage VTRG from the outside. The neuron circuit 130 may compare a value of the received membrane voltage VMEM with a value of the threshold voltage VTRG. When the comparison result indicates that the value of the membrane voltage VMEM is greater than the value of the threshold voltage VTRG, the neuron circuit 130 may output the output spike signal SPK_OUT.

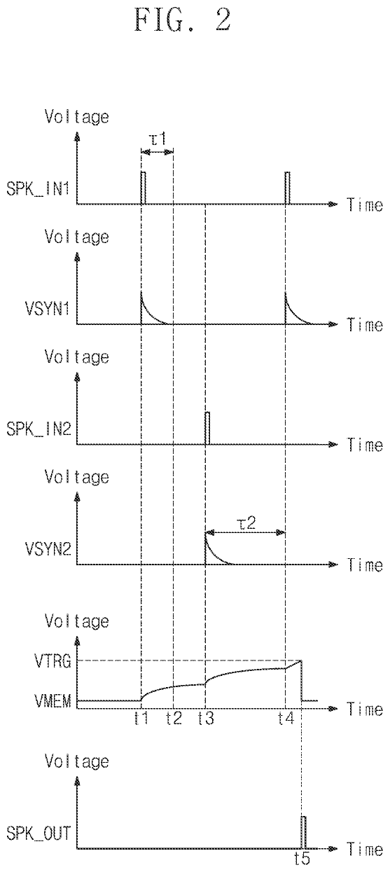

FIG. 2 is a timing diagram illustrating an operation of the spike neural network circuit 100 of FIG. 1. In FIG. 2, a horizontal axis represents a time (t), and a vertical axis represents a voltage.

Referring to FIGS. 1 and 2, the synaptic voltage generator 110 may receive the first input spike signal SPK_IN1 at a first time point t1 and may receive the second input spike signal SPK_IN2 at a third time point t3.

The synaptic voltage generator 110 may generate the first and second synaptic voltages VSYN1 and VSYN2 corresponding to the received first and second input spike signals SPK_IN1 and SPK_IN2. The generated first and second synaptic voltages VSYN1 and VSYN2 may decrease in units of a time constant of several milliseconds (ms) depending on natural decay. In this case, a value of a time constant τ1 of the first synaptic voltage VSYN1 is “t2-t1”, and a value of a time constant τ2 of the second synaptic voltage VSYN2 is “t4-t3”.

The synaptic circuit 120 may receive the first and second synaptic voltages VSYN1 and VSYN2 from the synaptic voltage generator 110. The synaptic circuit 120 may supply charges to the membrane capacitor CMEM based on the received first and second synaptic voltages VSYN1 and VSYN2. The amount of charge supplied to the membrane capacitor CMEM may slowly decrease over time, and thus the membrane voltage VMEM may naturally increase with a time constant of several milliseconds.

The neuron circuit 130 may receive the membrane voltage VMEM from the synaptic circuit 120 and may receive the threshold voltage VTRG from the outside. The neuron circuit 130 may compare the value of the received membrane voltage VMEM with the value of the threshold voltage VTRG. At a fifth time point t5, the value of the membrane voltage VMEM becomes greater than the value of the threshold voltage VTRG, and thus the neuron circuit 130 may output the output spike signal SPK_OUT.

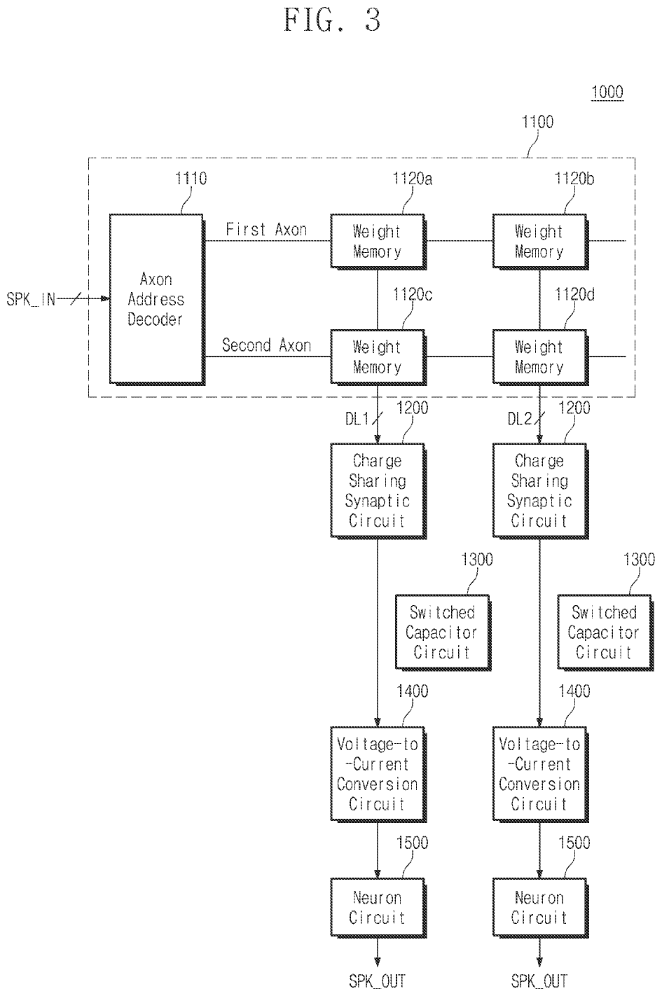

FIG. 3 is a block diagram showing a spike neural network circuit 1000, according to an embodiment of the present disclosure. For convenience of description, the spike neural network circuit 1000 in FIG. 3 shows only two charge sharing synaptic circuits, two switched capacitor circuits, two voltage current conversion circuits, and two neuron circuits, but the scope of the present disclosure is not limited thereto. Furthermore, it is shown that weight storage 1100 is arranged in first and second rows and first and second columns. However, the scope of the present disclosure is not limited thereto. For example, the weight storage 1100 may extend in a row direction or a column direction.

Referring to FIG. 3, the spike neural network circuit 1000 may include the weight storage 1100, a plurality of charge sharing synaptic circuits 1200, a plurality of switched capacitor circuits 1300, a plurality of voltage-to-current conversion circuits 1400, and a plurality of neuron circuits 1500.

The weight storage 1100 may include an axon address decoder 1110 and a plurality of weight memories 1120a to 1120d. A plurality of weight memories may be arranged at points where first and second rows (e.g. first and second axons) and first and second columns intersect with one another.

The axon address decoder 1110 may receive at least one input spike signal SPK_IN from the outside. The input spike signal SPK_IN may be composed of an input spike event of 1 bit and an axon address.

The axon address decoder 1110 may receive the input spike signal SPK_IN and may deliver an enable signal to an axon corresponding to an axon address. In this case, the enable signal may be a spike signal having a specific pulse width or a trigger signal operated in response to an edge. The enable signal may be a signal for allowing a plurality of weight memories connected to the corresponding axon to output data based on a weight value. The plurality of weight memories may deliver data to the charge sharing synaptic circuit 1200 through data lines DL1 and DL2 in response to the enable signal.

The plurality of weight memories 1120a to 1120d may store predefined weight values. The plurality of weight memories 1120a to 1120d may store different weight values from one another. When the plurality of weight memories 1120a to 1120d store different weight values, data values delivered to the data lines DL1 and DL2 may be different from each other.

The plurality of weight memories 1120a to 1120d may be implemented with a binary memory. For example, each of the plurality of weight memories 1120a to 1120d may be implemented with a memory capable of storing 6 bits. However, the scope of the present disclosure is not limited thereto. For example, the size of the binary memory may be variously implemented depending on the purpose of the spike neural network circuit 100.

The plurality of weight memories 1120a to 1120d may be implemented with, for example, volatile memories such as a static random access memory (SRAM), a dynamic RAM (DRAM), and a synchronous DRAM (SDRAM) or nonvolatile memories such as a phase-change RAM (PRAM), a magnetic RAM (MRAM), a resistive RAM (RRAM), and a ferroelectric RAM (FRAM) or may be implemented with a combination thereof.

The plurality of charge sharing synaptic circuits 1200 may receive data from the weight storage 1100 through the data lines DL1 and DL2. Each of the charge sharing synaptic circuits 1200 may determine an initial value of a synaptic voltage based on the received data.

Each of the charge sharing synaptic circuits 1200 may include a plurality of capacitors as passive elements. The plurality of capacitors may be positioned to share charges. As a result of charge sharing, the initial value of the synaptic voltage may be determined depending on a capacitance ratio of a plurality of capacitors.

Each of the charge sharing synaptic circuits 1200 may include a plurality of MOSFETs. The plurality of MOSFETs may operate as switches. Each of the plurality of MOSFETs may be turned on or off by receiving a control signal.

Each of the charge sharing synaptic circuits 1200 may include a voltage reference circuit composed of an operational amplifier (OPAMP) such that charges are shared between capacitors.

Each of the charge sharing synaptic circuits 1200 may include a C-DAC. The C-DAC may supply a current or charge to the neuron circuit 130 based on the weight provided from the weight memory. Alternatively, the C-DAC may supply charges to the membrane capacitor CMEM based on the weight provided from the weight memory.

Each of the plurality of switched capacitor circuits 1300 may be connected in parallel between the charge sharing synaptic circuit 1200 and the voltage-to-current conversion circuit 1400. Each of the switched capacitor circuits 1300 may operate such that the synaptic voltage determined from the charge sharing synaptic circuit 1200 is naturally discharged over time (or such that an initial value of the synaptic voltage returns to an original value). In this case, the synaptic voltage may have synapse short-term plasticity characteristics.

Each of the plurality of switched capacitor circuits 1300 may include at least one capacitor as a passive element. Besides, each of the switched capacitor circuits 1300 may include a plurality of MOSFETs. The plurality of MOSFETs may operate as switches. Each of the plurality of MOSFETs may be turned on or off by receiving a control signal. To minimize a circuit area, each of the switched capacitor circuits 1300 may share control signals and MOSFETs with the voltage-to-current conversion circuit 1400.

Each of the plurality of voltage-to-current conversion circuits 1400 may receive a synaptic voltage and may generate a membrane voltage. As the synaptic voltage is naturally discharged over time (or such that the initial value of the synaptic voltage returns to an original value), a membrane voltage may be naturally discharged over time. That is, the membrane voltage may have synapse short-term plasticity characteristics.

Each of voltage-to-current conversion circuits 1400 may include at least one capacitor as a passive element. At this time, the capacitor may accumulate charges from the synaptic voltage and may supply the accumulated charges to the neuron circuit 1500.

Moreover, each of the voltage-to-current conversion circuits 1400 may include a plurality of MOSFETs. The plurality of MOSFETs may operate as switches. Each of the plurality of MOSFETs may be turned on or off by receiving a control signal. To minimize a circuit area, each of the voltage-to-current conversion circuits 1400 may share control signals and MOSFETs with the switched capacitor circuit 1300.

Each of the voltage-to-current conversion circuits 1400 may include a voltage reference circuit composed of an operational amplifier (OPAMP) such that charges are shared between capacitors.

Each of the plurality of neuron circuits 1500 may receive a membrane voltage from the voltage-to-current conversion circuit 1400 and may receive a threshold voltage from the outside. Each of the neuron circuits 1500 may compare a value of the received membrane voltage with a value of the threshold voltage. When the comparison result indicates that the value of the membrane voltage is greater than the value of the threshold voltage, each of the neuron circuits 1500 may generate the output spike signal SPK_OUT.

Each of the neuron circuits 1500 may include a plurality of capacitors as passive elements. Moreover, each of the neuron circuits 1500 may include a plurality of MOSFETs. The plurality of MOSFETs may operate as switches. Each of the plurality of MOSFETs may be turned on or off by receiving a control signal.

In the above example, each of the control signals for controlling MOSFETs may be independent and have different cycles.

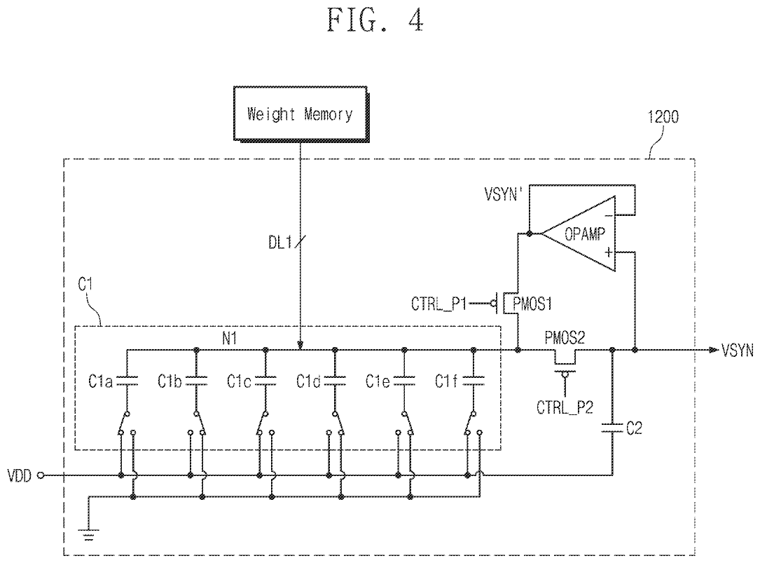

FIG. 4 shows the charge sharing synaptic circuit 1200, according to an embodiment of the present disclosure. In FIG. 4, it is assumed that a weight memory stores 6 bits and an initial voltage of a synaptic voltage VSYN is a reference voltage VDD.

Referring to FIGS. 3 and 4, the charge sharing synaptic circuit 1200 may include a first capacitor C1 and a second capacitor C2. The first capacitor C1 may be composed of first to sixth internal capacitors C1a to C1f. Each of the first to sixth internal capacitors C1a to C1f may be connected to the reference voltage VDD or a ground voltage GND depending on an operation of a switch.

A value of the first capacitor C1 may be determined depending on data received from a weight memory through data line DL1. For example, when the received data is ‘010110’, the first internal capacitor C1a, the third internal capacitor C1c, and the sixth internal capacitor C1f may be connected to the reference voltage VDD, and the second internal capacitor C1b, the fourth internal capacitor C1d, and the fifth internal capacitor C1e may be connected to the ground voltage GND.

Each of the first to sixth internal capacitors C1a to C1f may have a value of a power of 2 between ‘2⁰ C’ and ‘2⁵ C’. The second capacitor C2 may have a value of ‘2⁶ C’ greater than the sum of values of the first to sixth internal capacitors C1a to C1f.

The charge sharing synaptic circuit 1200 may include a plurality of switches. For example, the charge sharing synaptic circuit 1200 may include a first PMOS PMOS1 and a second PMOS PMOS2. The first PMOS PMOS1 and the second PMOS PMOS2 may be turned on or turned off by the first PMOS control signal CTRL_P1 and the second PMOS control signal CTRL_P2, respectively.

The charge sharing synaptic circuit 1200 may include a voltage reference circuit composed of an operational amplifier OPAMP such that charges are shared between the first capacitor C1 and the second capacitor C2.

Depending on whether the first PMOS PMOS1 and the second PMOS PMOS2 are turned on or off, the synaptic voltage VSYN may be determined by a capacitance ratio of the first capacitor C1 and the second capacitor C2. In this case, the synaptic voltage VSYN may be calculated from Equation 1 below.

$$VSYN = \frac{C 1}{C 1 + C 2} * VDD \qquad [ Equation 1 ]$$

On the other hand, the synaptic voltage VSYN may decrease in units of time constant of several milliseconds depending on natural decay. In the present disclosure, it is assumed that the initial voltage of the synaptic voltage VSYN is the reference voltage VDD. Accordingly, it will be understood that the natural decay in the present disclosure indicates that a value of the synaptic voltage VSYN is determined to be less than the reference voltage VDD by charge sharing and then is gradually returned to the reference voltage VDD.

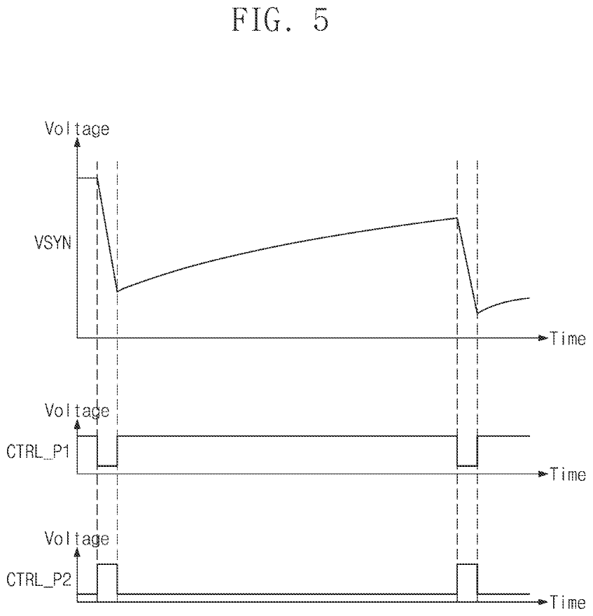

FIG. 5 is a timing diagram illustrating an operation of the charge sharing synaptic circuit 1200 of FIG. 4. In FIG. 5, a horizontal axis represents a time (t), and a vertical axis represents a voltage. Referring to FIGS. 4 and 5, when the first PMOS control signal CTRL_P1 transitions from ‘HIGH’ to ‘LOW’, the first PMOS PMOS1 is turned on. At this time, a voltage at the first node N1 may be equal to a current value of the synaptic voltage VSYN by the operational amplifier OPAMP. When the first PMOS control signal CTRL_P1 transitions from ‘LOW’ to ‘HIGH’ again and the first PMOS PMOS1 is turned off, the second PMOS control signal CTRL_P2 transitions from ‘HIGH’ to ‘LOW’ and the second PMOS PMOS2 is turned on. At the same time, charges accumulated in the first capacitor C1 and the second capacitor C2 are shared with each other, and an initial value of the synaptic voltage VSYN is determined by Equation 1.

In the meantime, only when an input spike event occurs and new data is received, the above-described operation may be performed in response to the first PMOS control signal CTRL_P1 and the second PMOS control signal CTRL_P2. When there is no input spike event, the first PMOS control signal CTRL_P1 and the second PMOS control signal CTRL_P2 may maintain state ‘HIGH’ and state ‘LOW’, respectively.

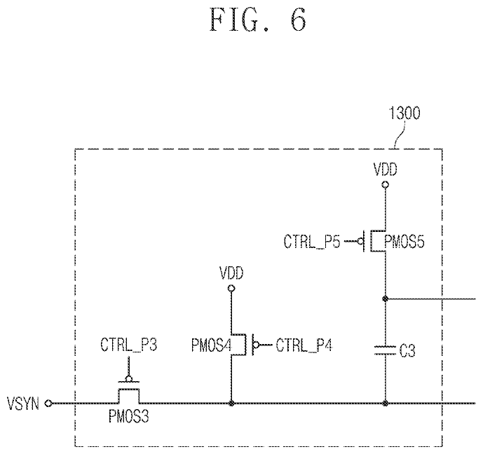

FIG. 6 shows the switched capacitor circuit 1300, according to an embodiment of the present disclosure.

Referring to FIGS. 3 and 6, the switched capacitor circuit 1300 may include a plurality of switches. For example, the switched capacitor circuit 1300 may include third to fifth PMOS PMOS3 to PMOS5. Each of the third to fifth PMOS PMOS3 to PMOS5 may be turned on or off by each of third to fifth PMOS control signals CTRL_P3 to CTRL_P5. In this case, the fourth PMOS PMOS4 and the fifth PMOS PMOS5 may be connected to the reference voltage VDD.

The switched capacitor circuit 1300 may include at least one capacitor. For example, the switched capacitor circuit 1300 may include a third capacitor C3. The third capacitor C3 may operate to deliver charges of the synaptic voltage VSYN to the membrane voltage VMEM.

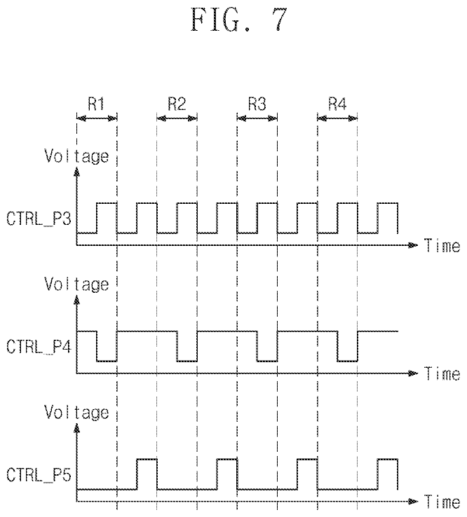

FIG. 7 is a timing diagram showing an operation of the switched capacitor circuit 1300 of FIG. 6. In FIG. 7, a horizontal axis represents a time, and a vertical axis represents a voltage.

Referring to FIGS. 6 and 7, in first to fourth regions R1 to R4, a third PMOS control signal CTRL_P3 may transition from ‘LOW’ to ‘HIGH’, and a fourth PMOS control signal CTRL_P4 may transition from ‘HIGH’ to ‘LOW’. Accordingly, the third PMOS may be turned off, and the fourth PMOS may be turned on. At this time, the charge of the synaptic voltage VSYN may move to the reference voltage VDD, and the synaptic voltage VSYN may be spontaneously discharged to the reference voltage VDD. The operation of the switched capacitor circuit 1300 described above is performed like a resistor. An equivalent resistance value may be implemented by adjusting transition periods of the third PMOS control signal CTRL_P3 and the fourth PMOS control signal CTRL_P4. For example, when the transition period is set to be long, an equivalent resistance of several mega ohms may be implemented with a small area and a time constant of several milliseconds may be implemented.

In the meantime, in the first to fourth regions R1 to R4, the fifth PMOS control signal CTRL_P5 maintains state ‘LOW’, and thus the fifth PMOS PMOS5 may be turned on.

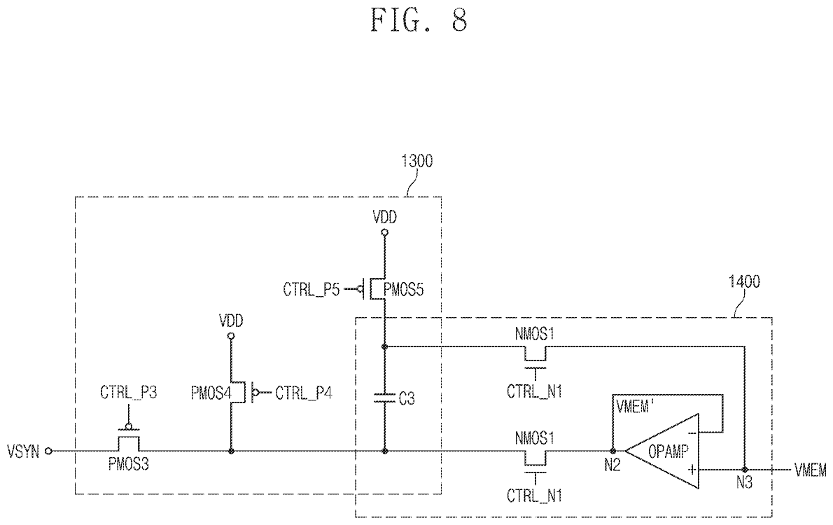

FIG. 8 shows the voltage-to-current conversion circuit 1400, according to an embodiment of the present disclosure.

Referring to FIGS. 3 and 8, the voltage-to-current conversion circuit 1400 may include a plurality of switches. For example, the voltage-to-current conversion circuit 1400 may include two first NMOSs NMOS1. The first NMOSs NMOS1 may be turned on or off by the first NMOS control signal CTRL_N1.

The voltage-to-current conversion circuit 1400 may include at least one capacitor. For example, the voltage-to-current conversion circuit 1400 may share the third capacitor C3 with the switched capacitor circuit 1300. The third capacitor C3 may accumulate charges from the synaptic voltage VSYN and supply the accumulated charges to the neuron circuit 1500.

The voltage-to-current conversion circuit 1400 may include a voltage reference circuit composed of an operational amplifier OPAMP. At this time, a voltage at a second node N2 may be equal to a voltage at a third node N3 by the operational amplifier OPAMP.

In the meantime, to minimize a circuit area, the voltage-to-current conversion circuit 1400 may share control signals and MOSFETs with the switched capacitor circuit 1300.

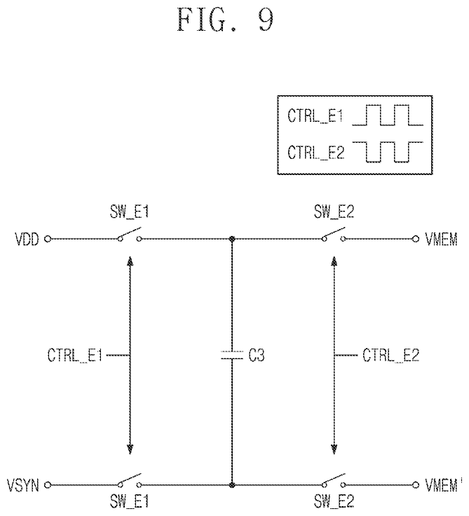

FIG. 9 shows an equivalent circuit of the voltage-to-current conversion circuit 1400 of FIG. 8. In FIG. 9, a first equivalent signal CTRL_E1 represents the third PMOS control signal CTRL_P3 and the fifth PMOS control signal CTRL_P5, and a second equivalent signal CTRL_E2 represents the first NMOS control signal CTRL_N1. Furthermore, state ‘HIGH’ of the first equivalent signal CTRL_E1 does not overlap state ‘HIGH’ of the second equivalent signal CTRL_E2.

Referring to FIGS. 8 and 9, when the first equivalent signal CTRL_E1 is in state ‘HIGH’ and the second equivalent signal CTRL_E2 is in state ‘LOW’, a first equivalent switch SW_E1 may be turned on, and a second equivalent switch SW_E2 may be turned off. Accordingly, because the reference voltage VDD and the synaptic voltage VSYN are applied to the third capacitor C3, charges as much as “VDD-VSYN” may be accumulated in the third capacitor C3.

Afterward, when the first equivalent signal CTRL_E1 is in state ‘LOW’ and the second equivalent signal CTRL_E2 is in state ‘HIGH’, the first equivalent switch SW_E1 may be turned off, and the second equivalent switch SW_E2 may be turned on. In this case, the amount of charge accumulated on the third capacitor C3 is maintained, the membrane voltage VMEM may be a voltage increased as much as ‘VDD-VSYN’ from the previous membrane voltage VMEM. When the above-described operation is repeated, the membrane voltage VMEM continuously increases as much as a difference between the reference voltage VDD and the synaptic voltage VSYN.

In the meantime, because the synaptic voltage VSYN returns to the reference voltage VDD by synapse short-term plasticity characteristics, the amount of charge delivered to the membrane voltage VMEM may be reduced. Accordingly, the membrane voltage VMEM may have biological increase characteristics depending on the synapse short-term plasticity characteristics.

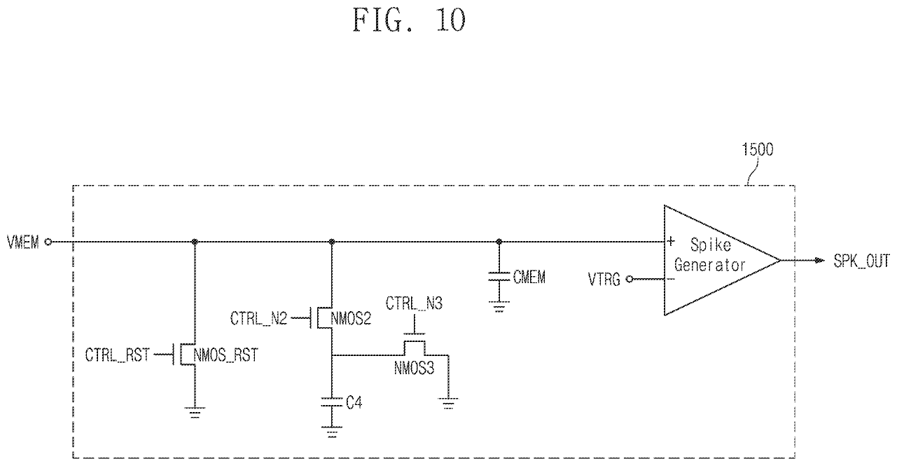

FIG. 10 shows the neuron circuit 1500, according to an embodiment of the present disclosure. Referring to FIGS. 3 and 10, the neuron circuit 1500 may include a spike generator. The spike generator may receive the membrane voltage VMEM from the voltage-to-current conversion circuit 1400 and may receive the threshold voltage VTRG from the outside. The neuron circuit 1500 may compare a value of the received membrane voltage VMEM with a value of the threshold voltage VTRG. When the comparison result indicates that the value of the membrane voltage VMEM is greater than the value of the threshold voltage VTRG, the neuron circuit 1500 may generate the output spike signal SPK_OUT.

The neuron circuit 1500 may include a plurality of switches. For example, the neuron circuit 1500 may include a reset NMOS NMOS_RST, a second NMOS NMOS2, and a third NMOS NMOS3.

The reset NMOS NMOS_RST may be turned on or off by an initialization control signal CTRL_RST. When the spike generator generates a spike signal, the reset NMOS NMOS_RST may be turned on by the initialization control signal CTRL_RST, and the membrane voltage VMEM may be initialized.

The second NMOS NMOS2 and the third NMOS NMOS3 may be turned on or off by a second NMOS control signal CTRL_N2 and a third NMOS control signal CTRL_N3, respectively.

The neuron circuit 1500 may include a plurality of capacitors. For example, the neuron circuit 1500 may include a fourth capacitor C4 and a membrane capacitor CMEM.

The fourth capacitor C4 may control the amount of charge accumulated in the membrane capacitor CMEM. For example, the fourth capacitor C4 may adjust the amount of charge accumulated in the membrane capacitor CMEM depending on operations of the second NMOS NMOS2 and the third NMOS NMOS3. At this time, when the value of the fourth capacitor C4 is large, the fourth capacitor C4 may leak a lot of charges, and thus the fourth capacitor C4 may operate as a resistor having a low resistance.

The membrane capacitor CMEM may receive charges from the voltage-to-current conversion circuit 1400. The membrane capacitor CMEM may form the membrane voltage VMEM by accumulating the received charges.

On the other hand, when the value of the membrane capacitor CMEM is large, a potential rising with respect to the same current may be small. At this time, a frequency of the output spike signal SPK_OUT generated from the spike generator may be low. That is, the membrane capacitor CMEM may be regarded as the sensitivity of the spike to the same current.

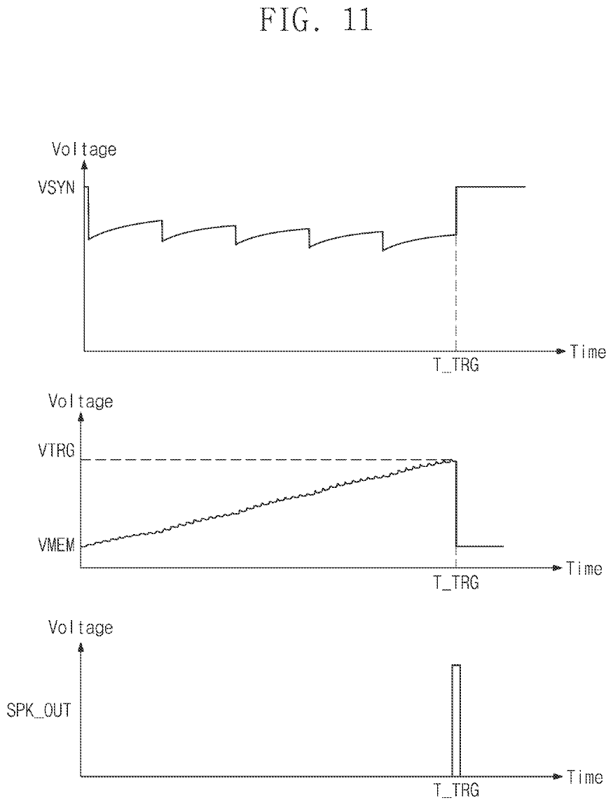

FIG. 11 is a timing diagram illustrating an operation of a spike neural network circuit, according to an embodiment of the present disclosure. In FIG. 11, a horizontal axis represents a time, and a vertical axis represents a voltage.

Referring to FIGS. 3 to 11, when a spike input event is applied, the synaptic voltage VSYN may be rapidly reduced depending on a weight from the initial reference voltage VDD. The reduced synaptic voltage VSYN may be increased to the reference voltage VDD value by an operation of the switched capacitor circuit 1300. As the synaptic voltage VSYN increases, the membrane voltage VMEM may also increase. While the synaptic voltage VSYN naturally increases depending on a specific time constant by synapse short-term plasticity characteristics, the increasing slope of the membrane voltage VMEM may also change. The moment when the gradually increased membrane voltage VMEM exceeds the threshold voltage VTRG, the neuron circuit 1500 may fire. At this time, the synaptic voltage VSYN and the membrane voltage VMEM may be initialized.

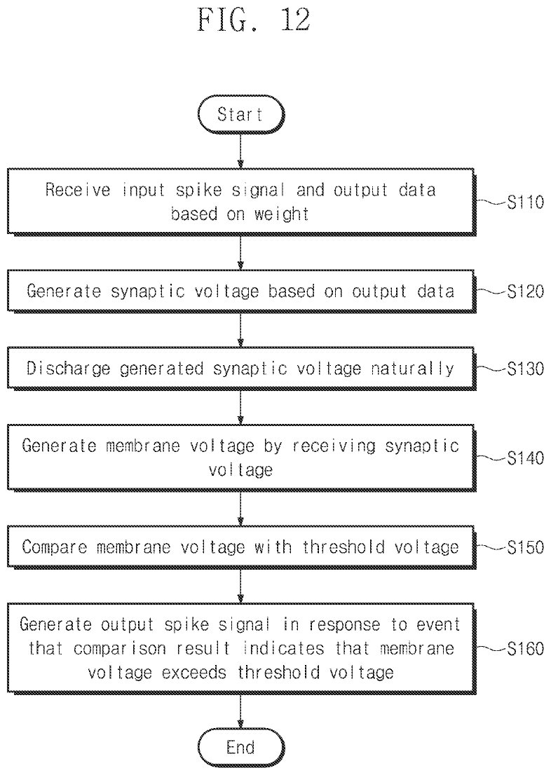

FIG. 12 is a flowchart showing an operation of the spike neural network circuit 1000, according to an embodiment of the present disclosure. Referring to FIGS. 3 and 12, in operation S110, the weight storage 1100 may receive an input spike signal and output data based on a weight. In this case, the axon address decoder 1110 may control a weight memory so as to output the data based on axon address information.

In operation S120, the charge sharing synaptic circuit 1200 may generate a synaptic voltage based on the output data. In this case, the synaptic voltage may be generated based on a capacitance ratio of capacitors of the charge sharing synaptic circuit 1200.

In operation S130, the switched capacitor circuit 1300 may naturally discharge the generated synaptic voltage. In this case, the synaptic voltage may have synapse short-term plasticity characteristics.

In operation S140, the voltage-to-current conversion circuit 1400 may generate a membrane voltage by receiving a synaptic voltage. The generated membrane voltage may increase based on the natural discharge of the synaptic voltage.

In operation S150, the neuron circuit 1500 may receive the membrane voltage and a threshold voltage. The neuron circuit 1500 may compare the received membrane voltage with the received threshold voltage.

In operation S160, the neuron circuit 1500 may generate an output spike signal in response to an event that the comparison result indicates that the membrane voltage exceeds the threshold voltage. At this time, the synaptic voltage and the membrane voltage may be initialized.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

The above-mentioned description refers to embodiments for implementing the scope of the present disclosure. Embodiments in which a design is changed simply or which are easily changed may be included in the scope of the present disclosure as well as an embodiment described above. In addition, technologies that are easily changed and implemented by using the above-mentioned embodiments may be also included in the scope of the present disclosure.

According to an embodiment of the present disclosure, it is possible to implement a semiconductor, which is insensitive to process changes and enables consistent operation, by using only a capacitor as a passive element inside a circuit. Moreover, it is possible to reliably simulate natural decrease characteristics corresponding to several milliseconds of a voltage in synapse and neuron operations by using charge sharing characteristics of a capacitor. Accordingly, it is possible to provide a spike neural network circuit that mimics biological waveforms and actions such as synapse short-term plasticity.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A spike neural network circuit comprising:
a weight storage configured to receive an input spike signal and to output data based on a weight;
a charge sharing synaptic circuit configured to generate a synaptic voltage based on the output data;
a switched capacitor circuit configured to naturally discharge the generated synaptic voltage;
a voltage-to-current conversion circuit configured to receive the synaptic voltage and to generate a membrane voltage; and
a neuron circuit configured to receive the membrane voltage and a threshold voltage and to generate an output spike signal based on the received membrane voltage and the received threshold voltage.

2. The spike neural network circuit of claim 1, wherein the input spike signal includes an input spike event and axon address information.

3. The spike neural network circuit of claim 2, wherein the weight storage includes a weight memory configured to store the weight, and an axon address decoder, and
wherein the axon address decoder configured to control the weight memory so as to output the data based on the axon address information.

4. The spike neural network circuit of claim 1, wherein the charge sharing circuit includes a first capacitor and a second capacitor, and
wherein the first capacitor includes a plurality of internal capacitors having different values.

5. The spike neural network circuit of claim 4, wherein the charge sharing synaptic circuit generates the synaptic voltage based on a capacitance ratio between the first capacitor and the second capacitor.

6. The spike neural network circuit of claim 1, wherein the switched capacitor circuit includes a plurality of switches, and is naturally discharged based on operations of the plurality of switches.

7. The spike neural network circuit of claim 6, wherein the plurality of switches operate under control of a plurality of control signals.

8. The spike neural network circuit of claim 7, wherein the plurality of control signals have different periods, respectively.

9. The spike neural network circuit of claim 1, wherein the neuron circuit compares the membrane voltage with the threshold voltage, and generates the output spike signal in response to an event that the comparison result indicates that the membrane voltage exceeds the threshold voltage.

10. The spike neural network circuit of claim 1, wherein the membrane voltage increases based on the synaptic voltage.

11. An operating method of a spike neural network circuit, the method comprising:
receiving an input spike signal and outputting data based on a weight;
generating a synaptic voltage based on the output data;
naturally discharging the generated synaptic voltage;
receiving the synaptic voltage and generating a membrane voltage;
comparing the membrane voltage with a threshold voltage; and
generating an output spike signal in response to an event that the comparison result indicates that the membrane voltage exceeds the threshold voltage.

12. The method of claim 11, further comprising:
initializing the synaptic voltage and the membrane voltage in response to generating the output spike signal.

13. The method of claim 11, wherein the membrane voltage increases based on the synaptic voltage.
